(19) United States
(12) Patent Application Publication
(10) Pub. No.: US 2008/0099163 A1
(43) Pub. Date: May 1, 2008

(54) Overhead door sealing apparatus

(76) Inventor: Garry Bachiu, Assiniboia (CA)

Correspondence Address: NIXON & VANDERHYE, PC, 901 NORTH GLEBE ROAD, 11TH FLOOR, ARLINGTON, VA, 22203, US

(21) Appl. No.: 11/976,677

(22) Filed: Oct. 26, 2007

(30) Foreign Application Priority Data
Oct. 26, 2006 (CA) 2,565,904

(51) Int. Cl. E06B 7/16

(52) U.S. Cl. 160/209

(57) ABSTRACT

An apparatus for sealing an overhead door against a door frame includes an arm member comprising an arm and a flange on an upper end of the arm. The arm member is attached to the overhead door such that the arm extends above the top edge of the overhead door. A slotted plate member is attached to the door frame above a door opening and comprises a plate configured such that the plate curves upward and inward above a curved path followed by the top edge of the overhead door as it approaches the closed position. A slot is defined in the plate and as the overhead door approaches the closed position, the arm moves into the slot with the flange above the plate, and when the overhead door is in the closed position the flange contacts the plate to maintain the overhead door adjacent to the door frame.

This invention relates to overhead doors and in particular to an apparatus for sealing the top of the door against the door frame.

### BACKGROUND

Because of the relatively large expanse of an overhead door, particularly those used in large commercial buildings, wind forces often push the top of the overhead door away from the frame and its seal when the overhead door is in its down position, allowing heat to escape and allowing dust and snow to enter the building.

This problem has been addressed in the prior art by providing a slotted plate mounted at a midpoint of the top inner edge of the door frame, and an arm mounted on the door and configured to engage the slot. The plate is sloped from vertical and when the door closes the arm engages the slot and then a head on the end of the arm bears against the inner face of the plate and draws the door toward the frame as the head moves along the sloped plate when the door moves down to the closed position.

For example U.S. Pat. No. 3,265,118 to Smith discloses such an apparatus where the arm is pivotally attached to the top of the door. U.S. Pat. Nos. 3,424,223 to Rosenblatt and 5,819,834 to Wedekind disclose such apparatuses where the arm is fixed to the top of the door.

U.S. Pat. No. 6,112,799 to Mullet et al. discloses a plate mounted at a midpoint of the top inner edge of the door frame, again at an angle from vertical. A corresponding plate is mounted to the top of the door at a cooperating opposite angel such that when the door closes the plate on the door slides behind the plate on the frame and bears against same, drawing the door toward the frame.

In the above prior art devices the length of door travel from where the arm or plate on the door first engages the plate on the frame is quite short. Thus for example in the Smith apparatus, the arm must engage the slot near the head in order for the head to begin to bear against the back of the plate during the short distance of travel before the door is closed. The other devices are similarly configured, and so there is little room for error. Since the rollers and tracks commonly used for garage doors are not made to particularly close tolerances, frequent adjustment is required in order to ensure proper engagement of the two parts of the apparatus so that the door is forced against the frame seal. Especially on wider doors, a wind pushing on the panel may bend the panel sufficiently that the parts do not engage. Similarly where the door panel becomes warped, engagement may be problematic.

### SUMMARY OF THE INVENTION

It is an object of the present invention to provide an apparatus for sealing the top of an overhead door against the door frame that overcomes problems in the prior art.

In a first embodiment the present invention provides an apparatus for sealing an overhead door against a door frame, such that when the overhead door is in a closed position, a top edge of the overhead door is held adjacent to an inner face of the door frame. The apparatus comprises an arm member comprising an arm and a flange on an upper end of the arm, the arm member adapted for attachment to an upper portion of the overhead door such that the arm extends above the top edge of the overhead door. A slotted plate member is adapted for attachment to the door frame above a door opening defined by the door frame, and the slotted plate member comprises a plate configured such that, when the slotted plate member is attached to the door frame, the plate extends in a curved configuration upward and inward from a location above a top edge of the overhead door in the closed position to an inner edge beyond an inside surface of the overhead door in the closed position, such that the plate is above a curved path followed by the top edge of the overhead door as it approaches the closed position. A slot is defined in the plate and has an open end on the inner edge of the plate. The arm member and slotted plate member are configured and attached such that as the overhead door approaches the closed position the arm moves into the slot with the flange above the plate, and when the overhead door is in the closed position the flange contacts the plate to maintain the top edge of the overhead door adjacent to the inner face of the door frame.

In a second embodiment the present invention provides an overhead door apparatus comprising a door frame defining a door opening in a structure, and an overhead door mounted to the door frame such that the overhead door can move from an open position inside the structure above the door opening, to a closed position where the overhead door covers the door opening and where a top edge of the overhead door is adjacent to an inner face of the door frame. An arm member comprises an arm and a flange on an upper end of the arm, and the arm member is attached to an upper portion of the overhead door such that the arm extends above the top edge of the overhead door. A slotted plate member is attached to the door frame above the door opening and the slotted plate member comprises a plate configured such that the plate extends in a curved configuration upward and inward from a location above the top edge of the overhead door in the closed position to an inner edge beyond an inside surface of the overhead door in the closed position and such that the plate is above a curved path followed by the top edge of the overhead door as it approaches the closed position. A slot is defined in the plate and has an open end on the inner edge of the plate. The arm member and slotted plate member are configured and attached such that as the overhead door approaches the closed position the arm moves into the open end of the slot with the flange above the plate, and when the overhead door is in the closed position the flange contacts the plate to maintain the top edge of the overhead door adjacent to the inner face of the door frame.

The configuration allows the arm to engage the slot in the slotted plate a significant distance from the frame, such that the length of door travel from where the arm on the door first engages the plate on the frame is significantly increased compared to the prior art. With this configuration the arm enters the slot considerably prior to the door being completely closed. Thus if a wind is blowing against the door panel the full force thereof is not yet being borne by the door panel, since the door panel is at that time oriented at an angle and the wind is deflected through the gap between the door panel and the door frame, which is open at the time of engagement. In the angled orientation the door panel is also more resistant to bending forces exerted by the wind that tend to bend the middle of the door panel and force it away from the door frame.

Once the arm is engaged in the slot the plate can be curved or configured as required to locate the flange in the desired location when the door is fully closed. With the arm thus engaged in the slot, the apparatus will draw the door panel against the frame in spite of considerable wind forces.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a front view of an embodiment of the arm member of an apparatus of the present invention mounted on an overhead door;

FIG. 2 is a front view of a slotted plate member of the embodiment of FIG. 1 mounted on a door frame;

FIG. 3 is a side view of the embodiment of FIG. 1 mounted on a door and door frame with the door in the closed position;

FIG. 4 is a side view of the embodiment of FIG. 1 mounted on a door and door frame as in FIG. 3 with the door approaching the closed position and the arm just about to engage the slotted plate.

### DETAILED DESCRIPTION OF THE ILLUSTRATED EMBODIMENTS

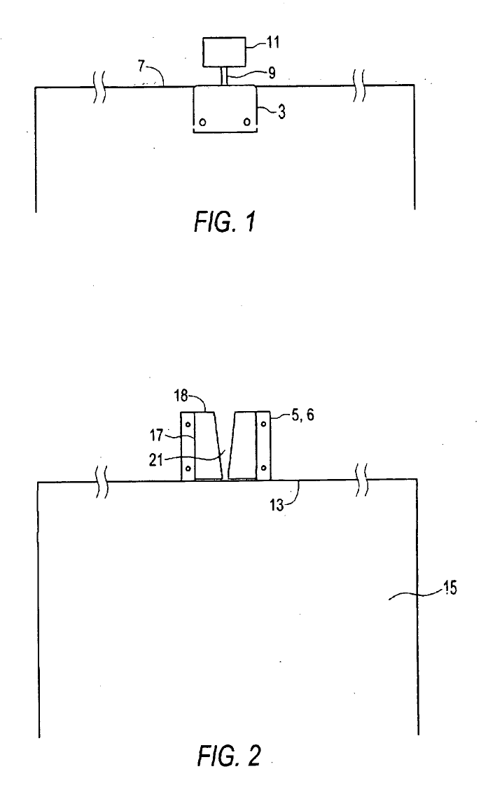

FIGS. 1-4 illustrate an apparatus 1 of the present invention for sealing an overhead door against a door frame, such that when the overhead door is in a closed position, a top edge of the overhead door 7 is held adjacent to an inner face of the door frame to seal the top of the overhead door against the door frame. The apparatus 1 comprises an arm member 3 and a slotted plate member 5. The arm member 3 comprises a narrow arm 9 with a flange 11 on the upper end of the arm 9, and the arm member 3 is adapted for attachment to an upper portion of the overhead door 7 such that the arm 9 extends above the top edge of the overhead door 7. The illustrated arm member 3 is configured to fit over the top edge of the door 7 and be secured by screws or the like.

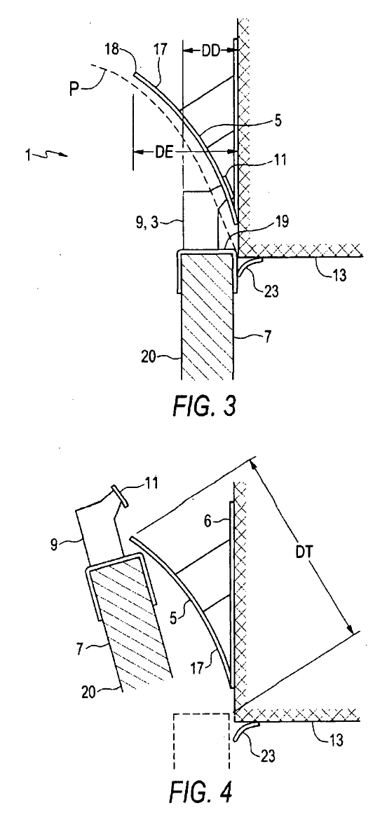

The slotted plate member 5 adapted for attachment to the door frame 13 above a door opening 15 defined by the door frame 13. The slotted plate member 5 comprises a plate 17 configured such that, when the slotted plate member 5 is attached to the door frame 13, the plate extends in a curve upward and inward from a location above a top edge of the overhead door 7 in the closed position illustrated in FIG. 3, to an inner edge 18 that is beyond an inside surface 20 of the overhead door 7 in the closed position such that the plate 17 is above a curved path P followed by the top edge of the overhead door 7 as it approaches the closed position.

Locating the inner edge 18 of the plate 17 beyond the inside face 20 of the door 7 greatly increases the length of door travel DT from where the arm 9 on the door first engages the slotted plate 17 to the fully closed position of FIG. 4 compared to the prior art. In the illustrated embodiment the inner edge 18 of the plate 17 is located at a distance DE from the inner face 20 of the door frame 13 that is about twice the distance DD from the inner surface of the door frame to the inside surface of the overhead door when the overhead door is in the closed position. It is contemplated that the distance DT that the door travels after the arm 9 enters the slot 21 will typically be 5 inches or more to provide sure engagement of the arm 9 in the slot 21.

The slotted plate member 5 has a base plate 6 that is secured to the door frame 13 above the door opening 15 by screws or the like. The plate 17 is curved to generally follow the curved path P followed by the top edge 19 of the door 7 in a conventional overhead door as it approaches the closed position shown in FIG. 3. The plate 17 is located just above the path P of the top edge 19 of the door 7. The plate 17 defines a slot 21 with an open end on an inner edge 18 of the plate 17.

The arm member 3 and slotted plate member 5 are attached at the middle of the door 7. Since the door 7 is held against the door frame at outer ends thereof by the tracks in which it moves, it is at the mid point where wind will cause the most deformation of the top edge of the door, and thus where the force exerted by the apparatus 1 is most needed.

The arm member 3 and slotted plate member 5 are configured and attached such that as the overhead door 7 approaches the closed position, as illustrated in FIG. 4, the arm 9 moves into the slot 21 with the flange 11 above the plate 17, and when the overhead door 7 is in the closed position of FIG. 3, the flange 11 contacts the plate 17 to maintain the top edge of the overhead door 7 adjacent to the inner face of the door frame 13. It is contemplated that in a typical installation as the arm 9 moves along the slot 21, the flange 11 on the end moves closer to the inner face of the plate 17 until it bears against the curved plate 17 at which time it draws the door 7 toward the frame 13 and typically a door seal 23.

In the present invention the arm 9 can be longer to ensure that the arm 9 enters the slot 21 and the flange 11 is on the back side of the plate 17. Once the arm 9 is engaged in the slot 21 the plate 17 can be curved so that the flange 9 moves toward the plate 17, and as required to locate the flange 11 in the desired location when the door 7 is fully closed.

The configuration allows the arm 9 to engage the slot 21 in the slotted plate 17 a significant distance from the frame 13. The illustrated slot 21 is also somewhat wider at the top open end to provide a larger target for the arm 9 and further ensure engagement. The length of door travel DT from where the arm 9 on the door first engages the slotted plate 17 to the fully closed position is significantly increased compared to the prior art. Thus the slot 21 can be quite wide at the inner edge 18 of the plate 17 so that there is little risk that wind forces or play in the door rollers will cause a misalignment such that the arm 9 does not move into the slot 21. The slot 21 can then become more narrow and guide the arm 9 into the proper location.

It is contemplated that the slotted plate member could be made significantly longer than the illustrated embodiment if desired for a particular door application. The path of the top edge of any door can be determined, and then the arm member 3 and slotted plate member 5 can be configured to provide the required relationship to engage the arm 9 in the slot 21, and to have the flange 11 bear against the plate 17 to draw the door 7 against the seal 23 on the door frame 13 in the closed position.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. An apparatus for sealing an overhead door against a door frame, such that when the overhead door is in a closed position, a top edge of the overhead door is held adjacent to an inner face of the door frame, the apparatus comprising:
an arm member comprising an arm and a flange on an upper end of the arm, the arm member adapted for attachment to an upper portion of the overhead door such that the arm extends above the top edge of the overhead door;
a slotted plate member adapted for attachment to the door frame above a door opening defined by the door frame, the slotted plate member comprising a plate configured such that, when the slotted plate member is attached to the door frame, the plate extends in a curved configuration upward and inward from a location above a top edge of the overhead door in the closed position to an inner edge beyond an inside surface of the overhead door in the closed position, such that the plate is above a curved path followed by the top edge of the overhead door as it approaches the closed position;
a slot defined in the plate and having an open end on the inner edge of the plate;
wherein the arm member and slotted plate member are configured and attached such that as the overhead door approaches the closed position the arm moves into the slot with the flange above the plate, and when the overhead door is in the closed position the flange contacts the plate to maintain the top edge of the overhead door adjacent to the inner face of the door frame.

2. The apparatus of claim 1 wherein the slot is tapered such that the slot is wider at the open end than at an end adjacent to the door frame.

3. The apparatus of claim 1 wherein the inner edge of the plate is located at a distance from the inner face of the door frame that is greater than 1.5 times a distance from the inner surface of the door frame to the inside surface of the overhead door when the overhead door is in the closed position.

4. The apparatus of claim 1 wherein the overhead door travels a distance of at least 5 inches after the arm enters the slot.

5. The apparatus of claim 1 wherein the slotted plate member comprises a base plate adapted to be secured to the door frame above the door opening.

6. The apparatus of claim 1 wherein the arm member is configured to fit over the top edge of the overhead door.

7. An overhead door apparatus comprising:
a door frame defining a door opening in a structure;
an overhead door mounted to the door frame such that the overhead door can move from an open position inside the structure above the door opening, to a closed position where the overhead door covers the door opening and where a top edge of the overhead door is adjacent to an inner face of the door frame;
an arm member comprising an arm and a flange on an upper end of the arm, the arm member attached to an upper portion of the overhead door such that the arm extends above the top edge of the overhead door;
a slotted plate member attached to the door frame above the door opening, the slotted plate member comprising a plate configured such that the plate extends in a curved configuration upward and inward from a location above the top edge of the overhead door in the closed position to an inner edge beyond an inside surface of the overhead door in the closed position and such that the plate is above a curved path followed by the top edge of the overhead door as it approaches the closed position;
a slot defined in the plate and having an open end on the inner edge of the plate;
wherein the arm member and slotted plate member are configured and attached such that as the overhead door approaches the closed position the arm moves into the open end of the slot with the flange above the plate, and when the overhead door is in the closed position the flange contacts the plate to maintain the top edge of the overhead door adjacent to the inner face of the door frame.

8. The apparatus of claim 7 wherein the slot is tapered such that the slot is wider at the open end than at an end adjacent to the door frame.

9. The apparatus of claim 7 wherein the inner edge of the plate is located at a distance from the inner face of the door frame that is greater than 1.5 times a distance from the inner surface of the door frame to the inside surface of the overhead door when the overhead door is in the closed position.

10. The apparatus of claim 7 wherein the overhead door travels a distance of at least 5 inches after the arm enters the slot.

11. The apparatus of claim 7 wherein the slotted plate member comprises a base plate adapted to be secured to the door frame above the door opening.

12. The apparatus of claim 7 wherein the arm member is configured to fit over the top edge of the overhead door.
